(19) United States
(12) Patent Application Publication
(10) Pub. No.: US 2025/0233237 A1
(43) Pub. Date: Jul. 17, 2025

(54) ALL-SOLID-STATE BATTERY

(71) Applicant: SAMSUNG ELECTRO-MECHANICS CO., LTD., Suwon-si, Gyeonggi-do (KR)

(72) Inventor: Jihyung Jung, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/690,887

(22) PCT Filed: Jan. 3, 2024
(86) PCT No.: PCT/KR2024/000145

§ 371 Date: Mar. 11, 2024

(30) Foreign Application Priority Data
Apr. 17, 2023 (KR) 10-2023-0049794

(51) Int. Cl. H01M 50/122; H01M 10/0585; H01M 50/46; H01M 50/474

(52) U.S. Cl. CPC H01M 50/122; H01M 10/0585; H01M 50/46; H01M 50/474

(57) ABSTRACT

An all-solid-state battery according to present disclosure includes a cell stack including a solid electrolyte layer, and a positive electrode layer and a negative electrode layer with the solid electrolyte layer disposed therebetween, and an outermost layer disposed on one surface or both surfaces of the cell stack in a stacking direction of the positive electrode layer, the solid electrolyte layer, and the negative electrode layer. The outermost layer includes an epoxy resin and glass particles, and the glass particles include a boron (B) oxide, a silicon (Si) oxide, and an aluminum (Al) oxide.

### TECHNICAL FIELD

The present disclosure relates to an all-solid-state battery.

### BACKGROUND ART

Recently, as portable electronic devices are required to be down-sized and used for a long term, high-capacity batteries are required, and safety of the batteries is also required due to the spread of wearable electronic devices. Accordingly, development of an all-solid-state battery using a solid electrolyte instead of a liquid electrolyte is actively progressing.

Since the all-solid-state battery does not use a flammable organic solvent, additional circuitry for safety may be simplified. Therefore, the all-solid-state battery is expected as a technology capable of manufacturing a safe battery with high capacity per unit volume.

In addition, an oxide all-solid-state battery using an oxide electrolyte with lower ionic conductivity (10⁻⁴ S/cm to 10⁻⁶ S/cm) than a sulfide electrolyte (10⁻² S/cm) requires a high-temperature sintering process but exhibits excellent stability, compared with a sulfide all-solid-state battery using the sulfide electrolyte which reacts oxygen and moisture in the air.

A stacked oxide all-solid-state battery is a micro-sized battery and thus may be mounted on a substrate like a passive device, and in addition, is stable even though exposed at a high temperature in a reflow process for this.

Research is being conducted to apply the stacked oxide all-solid-state battery to various fields, and in particular, demands for an all-solid-state battery having excellent insulation characteristics and moisture resistance are increasing.

### DISCLOSURE OF INVENTION

### Solution to Problem

One aspect of the embodiment provides an all-solid-state battery with improved reliability due to excellent insulation properties and moisture resistance.

However, problems to be solved by the embodiments are not limited to the above-described problems and may be variously expanded within the range of technical ideas included in the embodiments.

### Advantageous Effects of Invention

According to the all-solid-state battery according to the embodiment, both insulation properties and moisture resistance are improved, and thus the reliability of the battery can be improved.

However, the various advantageous advantages and effects of the present invention are not limited to the above descriptions, and will be more easily understood in the process of describing specific embodiments of the present invention.

### BRIEF DESCRIPTION OF DRAWINGS

FIG. 1 is a perspective view schematically illustrating an all-solid-state battery according to an embodiment.

FIG. 2 is a cross-sectional view of an all-solid-state battery according to an embodiment shown in FIG. 1.

FIG. 3 is a cross-sectional view of an all-solid-state battery according to another embodiment.

FIG. 4 is a cross-sectional view of an all-solid-state battery according to another embodiment.

FIG. 5 is a schematic view schematically illustrating the configuration of an outermost layer included in an all-solid-state battery according to an embodiment.

### BEST MODE FOR CARRYING OUT THE INVENTION

An all-solid-state battery according to an embodiment includes a cell stack including a solid electrolyte layer, and a positive electrode layer and a negative electrode layer with the solid electrolyte layer disposed therebetween, and an outermost layer disposed on one surface or both surfaces of the cell stack in a stacking direction of the positive electrode layer, the solid electrolyte layer, and the negative electrode layer. The outermost layer includes an epoxy resin and glass particles, and the glass particles include a boron (B) oxide, a silicon (Si) oxide, and an aluminum (Al) oxide.

The glass particles may not include lithium (Li) oxide.

The glass particles may further include other oxides, and the other oxides may include a bismuth (Bi) oxide, a barium (Ba) oxide, a phosphorus (P) oxide, a vanadium (V) oxide, an antimony (Sb) oxide, a tin (Sn) oxide, a zinc (Zn) oxide, or a combination thereof.

The glass particles may include 20 to 80 mol % of the boron (B) oxide, 10 to 50 mol % of the silicon (Si) oxide, 5 to 25 mol % of the aluminum (Al) oxide, and 0 to 20 mol % of the other oxides.

A surface of one of the glass particles may include a silane group.

The epoxy resin may include bisphenol A or a derivative thereof, bisphenol F or a derivative thereof, or a combination thereof.

A content of the glass particles may be 20 to 50 wt % based on the total weight of the outermost layer.

A content of the epoxy resin may be 50 to 80 wt % based on the total weight of the outermost layer.

An average thickness of the outermost layer may be less than or equal to 500 μm.

The solid electrolyte layer may include an oxide including lithium (Li), boron (B), silicon (Si), and aluminum (Al).

The cell stack may further include a margin layer disposed laterally on edges of the positive electrode layer and the negative electrode layer.

An insulating layer between the outermost layer and the cell stack may be further included.

An all-solid-state battery according to another embodiment includes a cell stack including a solid electrolyte layer, and a positive electrode layer and a negative electrode layer with the solid electrolyte layer disposed therebetween, an outermost layer disposed on one surface or both surfaces of the cell stack in a stacking direction of the positive electrode layer, the solid electrolyte layer, and the negative electrode layer, and an insulating layer disposed between the outermost layer and the cell stack. The outermost layer includes an epoxy resin and glass particles, and the glass particles include a boron (B) oxide, a silicon (Si) oxide, and an aluminum (Al) oxide.

The glass particles may not include lithium (Li) oxide.

The glass particles may further include other oxides, and the other oxides may include a bismuth (Bi) oxide, a barium (Ba) oxide, a phosphorus (P) oxide, a vanadium (V) oxide, an antimony (Sb) oxide, a tin (Sn) oxide, a zinc (Zn) oxide, or a combination thereof.

The glass particles may include 30 to 70 mol % of the boron (B) oxide, 20 to 40 mol % of the silicon (Si) oxide, 10 to 20 mol % of the aluminum (Al) oxide, and 0 to 10 mol % of the other oxides.

The epoxy resin may include bisphenol A or a derivative thereof, bisphenol F or a derivative thereof, or a combination thereof.

The solid electrolyte layer may include an oxide including lithium (U), boron (B), silicon (Si), and aluminum (Al).

A surface of the glass particle may include a silane group.

The cell stack may further include a margin layer disposed laterally on edges of the positive electrode layer and the negative electrode layer.

A stacked all-solid-state battery according to another embodiment includes a cell stack including a plurality of solid electrolyte layers and a plurality of positive electrode layers and negative electrode layers alternately disposed in a stacking direction with the plurality of solid electrolyte layers interposed therebetween, an outermost layer on one surface or both surfaces of the cell stack in the stacking direction, and first and second external electrodes disposed laterally on the cell stack and the outermost layer and connected to the plurality of positive electrode layers and the plurality of negative electrode layers, respectively. The outermost layer includes an epoxy resin and glass particles, and the glass particles include a boron (B) oxide, a silicon (Si) oxide, and an aluminum (A) oxide.

The glass particles may not include lithium (Li) oxide.

An insulating layer between the outermost layer and the cell stack may be further included.

### MODE FOR THE INVENTION

Hereinafter, various embodiments of the present invention will be described in detail with reference to the accompanying drawings so that those skilled in the art may easily carry out the present invention. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and substitutions without departing from the scope and spirit of the present invention. In addition, some constituent elements in the accompanying drawings are exaggerated, omitted, or schematically illustrated, and the size of each constituent element does not entirely reflect the actual size.

In addition, unless explicitly described to the contrary, the word “comprise”, and variations such as “comprises” or “comprising”, will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing. In addition, the “side direction” refers to a direction extending parallel to the large surface (main surface) from the edge of the sheet-shaped constituent elements or a “planar direction”, which corresponds to an L-axis direction in the drawing.

Hereinafter, various embodiments and modifications will be described in detail with reference to the drawings.

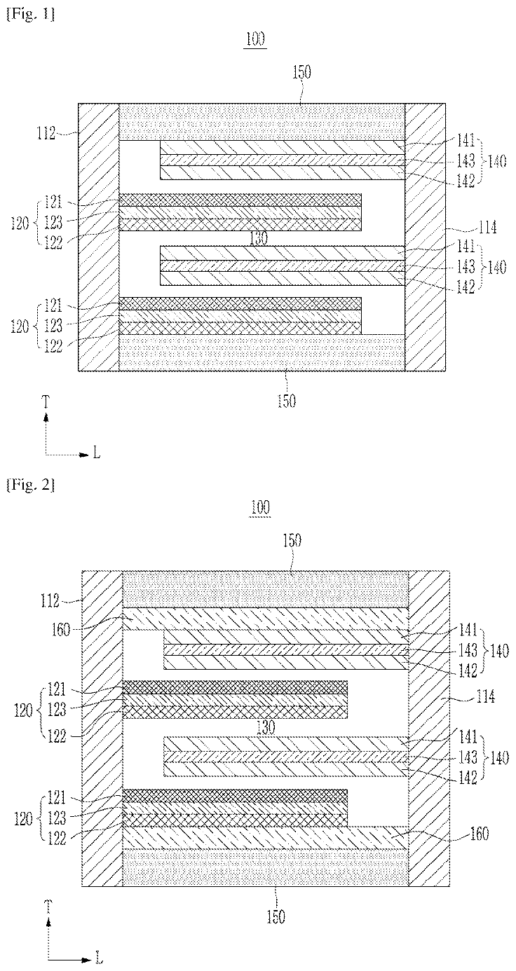

FIGS. 1 to 4 are cross-sectional views of an all-solid-state battery according to an embodiment, and the all-solid-state battery will be described in detail with reference to FIGS. 1 to 4.

The all-solid-state battery 100 may have, for example, an approximate hexahedral shape.

In the present embodiment, for better understanding and ease of description, in the all-solid-state battery 100, both surfaces facing each other in the thickness direction (T-axis direction) are defined as first and second surfaces, and both surfaces connected to the first and second surfaces and facing each other in the length direction (L-axis direction) are defined as third and fourth surfaces. For example, first and second sides facing each other of the all-solid-state battery 100 may be the third and fourth surfaces.

The all-solid-state battery 100 according to an embodiment includes electrode layers 120 and 140 and a solid electrolyte layer 130 adjacent to the electrode layers 120 and 140 in a stacking direction. The electrode layers 120 and 140 include a positive electrode layer 120 and a negative electrode layer 140, and basically the current collectors 123 and 143 and the active material layers 121, 122, 141, and 142 coated on at least one surface of the current collectors 123 and 143.

The positive electrode layer 120 is formed by coating the positive electrode active material layers 121 and 122 on at least one surface of the positive electrode current collector 123, and the negative electrode layer 140 is formed by coating the negative electrode active material layers 141 and 142 on at least one surface of the negative electrode current collector 143.

For example, in the stacking direction, the lowermost electrode layer is formed by coating the positive electrode active material layer 122 on one surface of the positive electrode current collector 123, and the uppermost electrode layer may be formed by coating the negative electrode active material layer 141 on one surface of the negative electrode current collector 143. In addition, the electrode layers between the uppermost and lowermost ends are formed by coating the positive electrode active material layers 121 and 122 on both surfaces of the positive electrode current collector 123, or the negative electrode active material layers 141 and 142 are formed on both surfaces of the negative electrode current collector 143.

The positive electrode active material layers 121 and 122 may include a positive electrode active material and, optionally, a solid electrolyte. In addition, the positive electrode active material layers 121 and 122 may optionally further include an additive such as a binder or a conductive agent.

For example, the positive electrode active material is not particularly limited as long as it can secure sufficient capacity of the all-solid-state battery 100. For example, positive electrode active material may include lithium cobalt oxide, lithium nickel cobalt manganese oxide, lithium nickel cobalt aluminum oxide, lithium iron phosphate, lithium manganese oxide, or a combination thereof.

For example, the positive electrode active material may be compounds represented by the following chemical formulas; LiₐA_{1-b}M_{b}D₂ (wherein 0.90≤a≤1.8, 0≤b≤0.5); LiₐE_{1-b}M_{b}O_{2-c}D_{c} (wherein 0.90≤a≤1.8, 0≤b≤0.5, 0≤c≤0.05); LiE_{2-b}M_{b}O_{4-c}D_{c} (wherein 0≤b≤0.5, 0≤c≤0.05); LiₐNi_{1-b-c}Co_{b}M_{c}D_{α} (wherein 0.905≤a≤1.8, 0≤b≤0.5, 0≤c≤0.05, 0<α≤2); LiₐN_{1-b-c}Co_{b}M_{c}O_{2-α}X_{α} (wherein 0.90≤a≤1.8, 0≤b≤0.5, 0≤c≤0.05, 0<α<2); Liₐ Ni_{1-b-c}CO_{b}M_{c}O_{2-α}X₂ (wherein 0.90≤a≤1.8, 0≤b≤0.5, 0≤c≤0.05, 0<α<2); LiₐNi_{1-b-c}Mn_{b}M_{c}D_{α} (wherein 0.90≤a≤1.8, 0≤b≤0.5, 0≤c≤0.05, 0<α<2); LiₐNi_{1-b-c}Mn_{b}M_{c}O_{2-α}X_{α} (wherein 0.90≤a≤1.8, 0≤b≤0.5, 0≤c≤0.05, 0<α<2); LiₐNi_{1-b-c}Mn_{b}M_{c}O_{2-α}X₂ (wherein 0.90≤a≤1.8, 0≤b≤0.5, 0≤c≤0.05, 0<α<2); LiₐNi_{b}E_{c}G_{d}O₂ (wherein 0.90≤a≤1.8, 0≤b≤0.9, 0≤c≤0.5, 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, 0.001≤e≤0.1); LiₐNiGbO₂ (wherein 0.90≤a≤1.8, 0.001≤b≤0.1); LiₐCoGbO₂ (wherein 0.90≤a≤1.8, 0.001≤b≤0.1); LiₐMnGbO₂ (wherein 0.90≤a≤1.8, 0.001≤b≤0.1); LiₐMn₂GbO₄ (wherein 0.90≤a≤1.8, 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₂ (wherein 0≤f≤2); and LiFePO₄, wherein in the above chemical formulas, A is Ni, Co, or Mn; M is Al, Ni, Co, Mn, Cr, Fe, Mg, Sr, V, or a rare-earth element; D is O, F, S, or P; E is Co or Mn; X is F. S. or P; G is Al, Cr, Mn, Fe, Mg, La, Ce, Sr. or V; Q is Ti, Mo, or Mn; R is Cr, V, Fe, Sc, or Y; and J is V, Cr, Mn, Co, Ni, or Cu.

The positive electrode active material may also be LiCoO₂, LiMnₓO₂ₓ (wherein x=1 or 2), LiN₁₋ₓMnₓO₂ₓ (wherein 0<x<1), LiNi_{1-x-y}CoₓMn_{y}O₂ (wherein 0≤x≤0.5, 0≤y≤0.5), LiFePO₄, TiS₂, FeS₂, TiS₃, or FeS₃.

As the solid electrolyte, a solid electrolyte usable in the solid electrolyte layer 130 described later may be used. The solid electrolyte may function as an ion conduction channel in the positive electrode layer 120, and through this, interface resistance may be reduced.

A content of the solid electrolyte may be greater than or equal to 0.1 parts by weight, greater than or equal to 1 part by weight, or greater than or equal to 10 parts by weight, and less than or equal to 80 parts by weight, less than or equal to 60 parts by weight, or less than or equal to 50 parts by weight based on 100 parts by weight of the total amount of the positive electrode active material.

The conductive agent is not particularly limited as long as it has conductivity without causing chemical change in the all-solid-state battery 100. For example, examples of the conductive agent may include graphite such as natural graphite and artificial graphite; carbon-based substances such as carbon black, acetylene black, ketjen black, channel black, furnace black, lamp black, and summer black; conductive fibers such as carbon fibers and metal Fibers; fluorinated carbon; metal powders such as aluminum and nickel powder, conductive whiskers such as zinc oxide and potassium titanate; conductive metal oxides such as titanium oxide; or conductive materials such as polyphenylene derivatives.

A content of the conductive agent may be 1 part by weight to 10 parts by weight, or for example, 2 parts by weight to 5 parts by weight, based on 100 parts by weight of the positive electrode active material. When the content of the conductive agent is within the above range, a finally obtained electrode may have excellent conductivity characteristics.

The binder may be used to improve bonding strength between an active material and a conductive agent. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene terpolymer (EPDM), sulfonated EPDM, a styrene butadiene rubber, a fluororubber, or various copolymers, and the like.

A content of the binder may be 1 part by weight to 50 parts by weight, or for example, 2 parts by weight to 5 parts by weight, based on 100 parts by weight of the total positive electrode active material. When the content of the binder satisfies the above range, the active material layer may have high bonding strength.

As the positive electrode current collector 123, a porous material such as a mesh or mesh shape may be used, and a porous metal plate such as stainless steel, nickel, or aluminum may be used. In addition, the positive electrode current collector 123 may be coated with an oxidation-resistant metal or alloy film to prevent oxidation.

The negative electrode active material layers 141 and 142 may include a negative electrode active material and, optionally, a solid electrolyte. In addition, the negative electrode active material layers 141 and 142 may optionally further include an additive such as a binder or a conductive agent.

The negative electrode active material may be a carbon-based material, silicon, a silicon oxide, a silicon-based alloy, a silicon-carbon-based material composite, tin, a tin-based alloy, a tin-carbon composite, a metal oxide, or a combination thereof, and may include a lithium metal and/or a lithium metal alloy.

The lithium metal alloy may include lithium and a metal/semi-metal capable of alloying with lithium. For example, the metal/semi-metal capable of alloying with lithium may include Si, Sn, Al, Ge, Pb, Bi, Sb, a Si—Y alloy (wherein Y is an alkali metal, an alkaline-earth metal, Group 13 to Group 16 elements, a transition metal, a rare earth element, or a combination thereof, and Si is not included), a Sn—Y alloy (wherein Y is an alkali metal, an alkaline earth metal, Group 13 to Group 16 elements, a transition metal, a transition metal oxide such as lithium titanium oxide (Li₄Ti₅O₁₂), a rare earth element, or a combination thereof, and Sn is not included), or MₙOₓ (0<x≤2).

The element Y may be Mg, Ca, Sr, Ba. Ra, Sc, Y, Ti, Zr, Hf, Rf, V. Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P. As, Sb, Bi, S, Se, Te, Po, or a combination thereof.

In addition, the oxide of a metal/semi-metal capable of alloying with lithium may be lithium titanium oxide, vanadium oxide, lithium vanadium oxide, SnO₂, SiOₓ (0<x≤2), and the like. For example, the negative electrode active material may include one or more elements selected from elements of Groups 13 to 16 of the periodic table of elements. For example, the negative electrode active material may include one or more elements selected from the group consisting of Si, Ge, and Sn.

The carbon-based material may be crystalline carbon, amorphous carbon, or a mixture thereof. The crystalline carbon may include graphite, such as natural graphite or artificial graphite in irregular, plate, flake, spherical, or fibrous form. In addition, the amorphous carbon may include soft carbon (low temperature calcined carbon) or hard carbon, a mesophase pitch carbonization product, calcined coke, graphene, carbon black, fullerene soot, a carbon nanotube, a carbon fiber, and the like.

The silicon may be Si, SiOₓ (0<x<2, for example 0.5 to 1.5), Sn, SnO₂, a silicon-containing metal alloy, or a mixture thereof. The silicon-containing metal alloy may include, for example, silicon and one or more of Al, Sn, Ag, Fe, Bi, Mg, Zn, in, Ge, Pb, and Ti.

As the solid electrolyte, a solid electrolyte usable in the solid electrolyte layer 130 described later may be used. The solid electrolyte may function as an ion conduction channel in the negative electrode layer 140, and through this, interface resistance may be reduced.

A content of the solid electrolyte may be greater than or equal to 0.1 parts by weight, greater than or equal to 1 part by weight, or greater than or equal to 10 parts by weight, and less than or equal to 80 parts by weight, less than or equal to 60 parts by weight, or less than or equal to 50 parts by weight based on 100 parts by weight of the total amount of the negative electrode active material.

The negative electrode active material layers 141 and 142 may also optionally include a conductive agent and a binder as described for the positive electrode active material layers 121 and 122.

As the negative electrode current collector 143, a porous material such as a mesh or mesh shape may be used, and a porous metal plate such as stainless steel, nickel, or aluminum may be used. In addition, the negative electrode current collector 143 may be coated with an oxidation-resistant metal or alloy film to prevent oxidation.

The solid electrolyte layer 130 may be disposed and stacked between the positive electrode layer 120 and the negative electrode layer 140. Accordingly, the solid electrolyte layer 130 may be adjacently disposed between the positive electrode active material layers 121 and 122 of the positive electrode layer 120 and the negative electrode active material layers 141 and 142 of the negative electrode layer 140 in the stacking direction.

Therefore, in the all-solid-state battery 100, a plurality of positive electrode layers 120 and a plurality of negative electrode layers 140 may be alternately disposed, and a plurality of solid electrolyte layers 130 may be interposed and stacked therebetween. In the all-solid-state battery 100, a plurality of positive electrode layers 120 and negative electrode layers 140 are alternately stacked, and a plurality of solid electrolyte layers 130 are interposed therebetween to manufacture a cell stack, and then the cell stack may be batch-fired to manufacture a stacked all-solid-state battery 100.

The solid electrolyte layer 130 may include an inorganic solid electrolyte including an oxide-type solid electrolyte, a sulfide-type solid electrolyte, or a combination thereof.

The oxide-type solid electrolyte may be Garnet-type, NASICON-type, LISICON-type, perovskite-type, LiPON-type, or amorphous (glass) electrolyte.

The garnet-based solid electrolyte may include lithium-lanthanum zirconium oxide (LLZO) represented by LiₐLa_{b}Zr_{c}O₁₂ such as Li₇La₃Zr₂O₁₂, and the NASICON-based solid electrolyte may include a lithium-aluminum-titanium-phosphate salt (LATP) of Li₁₊ₓAlₓTi₂₋ₓ(PO₄)₃ (0<x<1) in which Ti is introduced into a Li₁₊ₓAlₓM₂₋ₓ(PO₄)₃ (LAMP) (0<x<2, M is Zr, Ti, or Ge) type compound, lithium-aluminum-germanium-phosphate (LAGP) represented by Li₁₊ₓAlₓGe₂₋ₓ(PO₄)₃(0<x<1) such as Li_{1.3}Al_{0.3}Ti_{1.7}(PO₄)₃ introduced with excess lithium and/or lithium-zirconium-phosphate (LZP) of LiZr₂(PO₄)₃.

In addition, the LISICON-based solid electrolyte may be include a solid solution oxide represented by xLi₃AO₄-(1−x)Li₄BO₄ (wherein A is P, As, or V and B is Si, Ge, or Ti) such as Li₄Zn(GeO₄)₄, Li₁₀GeP₂O₁₂(LGPO), Li_{3.5}Si_{0.5}P_{0.5}O₄, or Li_{10.42}Si(Ge)_{1.5}P_{1.5} Cl_{0.08}O_{11.92}, or a solid solution sulfide represented by Li₄₋ₓM_{1-y}M′_{y}S₄ (wherein M is Si, or Ge and M′ is P, Al, Zn, or Ga) such as Li₂S—P₂S₅, Li₂S—SiS₂, Li₂S—SiS₂—P₂S₅, or Li₂SGeS₂.

The perovskite-based solid electrolyte may include lithium lanthanum titanate (LLTO) represented by Li₃ₓLa_{2/3-x}□_{1/3-2x}TiO₃ (0<x<0.16, □: vacancy) such as Li_{1/8}La_{5/8}TiO₃. The LiPON-based solid electrolyte may include a lithium phosphorous oxynitride such as Li_{2.8}PO_{3.3}N_{0.46}.

Examples of the amorphous electrolyte include Li₂O—B₂O—SiO₂, Li₂O—B₂O—P₂O₅, Li₃BO₃—Li₂SO₄, or Li₃BO₃—Li₂CO₃.

For example, the solid electrolyte includes an oxide-type solid electrolyte, and the oxide-type solid electrolyte may include an oxide including lithium (Li), boron (B), silicon (Si), and aluminum (Al). In other words, the oxide-type solid electrolyte may use an oxide usable for glass particles included in the outermost layer 150 to be described later, but further includes lithium oxide.

The oxide-type solid electrolyte may further include a bismuth (Bi) oxide, a barium (Ba) oxide, a phosphorus (P) oxide, a vanadium (V) oxide, an antimony (Sb) oxide, a tin (Sn) oxide, a zinc (Zn) oxide, or a combination thereof.

The lithium ionic conductivity of the oxide-type solid electrolyte included in the solid electrolyte layer 130 may be greater than or equal to 1×10⁻³ S/cm. The ionic conductivity may be measured at a temperature of 25° C. The ionic conductivity may be greater than or equal to 1×10⁻³ S/cm, greater than or equal to 2×10⁻³ S/cm, greater than or equal to 3×10⁻³ S/cm, greater than or equal to 4×10⁻³ S/cm, or greater than or equal to 5×10⁻³ S/cm, of which an upper limit is not particularly limited. When a solid electrolyte satisfying the ranges of ionic conductivity is used, the all-solid-state battery 100 may exhibit high power.

The outermost layer 150 may be disposed on one surface or both surfaces of the cell stack of the all-solid-state battery 100 in the stacking direction. For example, the outermost layer 150 may be disposed at the outermost side of the cell stack of the all-solid-state battery 100 in the stacking direction.

For example, the outermost layer 150 may warp the surface of the cell stack, so that one end of the positive electrode layer 120 may be exposed to the first surface and connected to the external electrode 112 at one side, while one end of the negative electrode layer 140 may be exposed to the second surface and connected to the external electrode 114 at the other side. For example, the outermost layer 150 may be disposed on the third and fourth surfaces except for the first and second surfaces of the cell stack or on the external surfaces of the lowermost positive electrode layer 120 and the uppermost negative electrode layer 140 in the stacking direction of the cell stack. Herein, the solid electrolyte layer 130 may be disposed between the outermost layer 150 and the positive electrode layer 120 or the negative electrode layer 140 adjacent thereto.

FIG. 5 is a schematic view schematically illustrating the configuration of an outermost layer included in an all-solid-state battery according to an embodiment. Referring to FIG. 5, the outermost layer 150 includes epoxy resin and glass particles.

Herein, the glass, in which a halo is observed in X-ray diffraction or electron beam diffraction, etc., is crystallographically amorphous.

The glass particles may include a boron (B) oxide, a silicon (Si) oxide, and an aluminum (Al) oxide but no lithium (Li) oxide. For example, the oxide-type solid electrolyte included in the solid electrolyte layer 130 may include oxides excluding the lithium (Li) oxide.

When the glass particles include the silicon (Si) oxide (SiO₂), the glass particles may be treated with silane to enhance a bonding force between the glass particles and the silane.

In addition, when the glass particles may include the aluminum (Al) oxide (Al₂O₃), there may be advantages of achieving excellent strength of the particles and controlling a thermal expansion coefficient to be small.

Since the glass particles include no lithium (Li) oxide (Li₂O) and thus no movement of lithium ions and resultantly, have very low ionic conductivity, an excellent insulation function may be achieved by suppressing self-discharge without generating leakage current.

Accordingly, the glass particles include the boron (B) oxide, the silicon (Si) oxide, and the aluminum (Al) oxide but no lithium (Li) oxide and thus may not only control a thermal expansion coefficient to be small to minimize mismatching with an epoxy resin due to an external temperature change but also have excellent insulation characteristics.

The glass particles may further include other oxides, and the other oxides include a bismuth (Bi) oxide, a barium (Ba) oxide, a phosphorus (P) oxide, a vanadium (V) oxide, an antimony (Sb) oxide, a tin (Sn) oxide, a zinc (Zn) oxide, or a combination thereof.

The content of the boron oxide (B₂O₃) may be 20 to 80 mol %, for example, 30 to 70 mol %, based on the total weight of the glass particles.

If the content of boron oxide (B₂O₃) is less than 10 mol %, the ionic conductivity may decrease, and if it exceeds 80 mol %, it may become vulnerable when exposed to a high humidity environment.

The content of the silicon oxide (SiO₂) may be 10 to 50 mol %, for example, 20 to 40 mol %, based on the total weight of the glass particles.

If the content of silicon oxide (SiO₂) is less than 10 mol %, it is difficult to sufficiently combine the glass particles with silane when the glass particles are subjected to silane treatment, and if the content exceeds 50 mol %, ionic conductivity may decrease.

The content of the aluminum oxide (Al₂O₃) may be 5 to 25 mol %, for example, 10 to 20 mol %, based on the total weight of the glass particles.

If the content of aluminum oxide (Al₂O₃) is less than 5 mol %, the thermal expansion coefficient of the glass particles cannot be controlled to be sufficiently small, and if it exceeds 25 mol %, ionic conductivity may decrease.

The content of the other oxides may be 0 to 20 mol %, for example 0 to 10 mol %, based on the total weight of the glass particles.

The content of each oxide is a content of each oxide in the glass particles, for example, a ratio of the content (mol) of each oxide to a total amount (mol) of the boron (B) oxide, the silicon (Si) oxide, the aluminum (Al) oxide, and other oxides is expressed as a percentage (mol %). The content of each oxide may be measured through inductively coupled plasma emission spectrometry (ICP-AES) and the like.

In an embodiment, in order to increase bonding strength with the epoxy resin and improve dispersion in the resin, the glass particles may include a silane group on the surface. For example, a silane coupling agent may be added to the glass particles to silanize the surface thereof.

The silane coupling agent may be represented by Chemical Formula RO—SiX₃, wherein RO is methoxy, ethoxy, or a combination thereof, and X may be an epoxy, acryloxy, metacryloxy, γ-glycidoxy, acryl, amino, mercapto, isocyanate group, or a combination thereof.

The content of the glass particles may be 20 to 50 wt % or 30 to 40 wt % based on a total weight of the outermost layer. When the content of the glass particles is less than 20 wt %, the mismatching with the epoxy resin due to external temperature change may be difficult to minimize, but when greater than 50 wt %, a process of manufacturing the outermost layer may not easily proceed.

The epoxy resin is a resin having excellent insulation properties, and may include a bisphenol type epoxy resin, a novolac type epoxy resin, a biphenyl type epoxy resin, a biphenyl ether type epoxy resin, or a combination thereof, but is not limited thereto. For example, a bisphenol type epoxy resin or a novolac type epoxy resin may be used from the viewpoint of increasing heat resistance.

For example, the bisphenol type epoxy resin may include bisphenol A or a derivative thereof, bisphenol F or a derivative thereof, or a combination thereof.

The epoxy resin is a material easily penetrated by external moisture due to its free volume, but the free volume of the epoxy resin may be reduced by including the glass particles therein, suppressing the moisture penetration and thus improving moisture resistant characteristics.

The content of the epoxy resin may be 50 to 80 wt % or 60 to 80 wt % based on the total weight of the outermost layer. When the content of the epoxy resin is less than 50 wt %, the glass particles may be difficult to sufficiently disperse in the epoxy resin, but when greater than 80 wt %, it may be difficult to realize excellent moisture resistant characteristics, and there may be the mismatching with the glass particles due to the external temperature change.

The outermost layer 150, in order to improve the moisture resistant characteristics of the all-solid-state battery 100, when exposed to 85° C. under RH 85% for 24 hours or more, may have a moisture absorption rate of less than or equal to 0.1 wt %, for example, less than or equal to 0.08 wt %. The moisture absorption rate of the outermost layer 150 may be measured by the following method. First, a portion of the outermost layer 150 in the all-solid-state battery 100 is sampled as a rectangular plate-shaped piece by ion milling or polishing. Next, the sample of the outermost layer is measured with respect to a weight before absorbing moisture and then, exposed to 85° C. under 85% RH for 24 hours or more and measured again with respect to a weight after absorbing moisture. The moisture absorption rate (%) may be calculated as follows.

$$[ Moisture absorption rate ( \% ) ]$$

$$( weight of sample after moisture absorption - weight of sample before moisture absorption ) * 100 / weight of sample before moisture absorption$$

Lithium (Li) ionic conductivity of the outermost layer 150, in order to prevent self-discharge of the all-solid-statc battery 100 and thus exhibit insulating characteristics, may be less than or equal to 1.0×10⁻⁸ S/cm, for example, less than or equal to 1.0×10⁻¹⁰ S/cm. The lithium (Li) ionic conductivity of the outermost layer 150 can be measured by an AC impedance method. First, a portion of the outermost layer 150 in the all-solid-state battery 100 is sampled as a rectangular plate-shaped piece by ion milling or polishing. Subsequently, electrodes made of gold (Au) are formed on both ends of the obtained piece to prepare a sample. Then, the sample is measured for alternating current impedance (frequency: 10⁺⁶ Hz to 10⁻¹ Hz, voltage: 100 mV, 1000 mV) at room temperature (25° C.) using an impedance measurement device to calculate the ionic conductivity.

The outermost layer 150 may have an average thickness of less than or equal to 500 μm, for example, less than or equal to 300 μm, or less than or equal to 100 μm. When the average thickness satisfies the ranges, an all-solid-state battery having high energy density as well as excellent insulation characteristics and water resistance may be realized.

The average thickness of the outermost layer 150 may be measured in the following method. First of all, a cross-section of the outermost layer 150 is prepared by ion milling and the like and then, taken an image of with a scanning electron microscope (SEM). Subsequently, in the cross-section SEM image, ten points are randomly selected and measured with respect to a thickness of the outermost layer 150, and an arithmetic mean of these ten measurements is calculated to obtain the average thickness of the outermost layer 150.

The all-solid-state battery according to an embodiment includes the outermost layer in the stacking direction of the cell stack on the outermost surface to effectively prevent penetration of external moisture and thus realize an excellent moisture resistant function and excellent insulation characteristics, resulting in preventing all-solid-state batty defects caused by deposition of lithium ion precipitates at the negative electrode during operation of the all-solid-state batty and thus improving reliability of the all-solid-state battery.

An all-solid-state battery according to an embodiment includes a cell stack including a solid electrolyte layer, and a positive electrode layer and a negative electrode layer with the solid electrolyte layer disposed therebetween, an outermost layer at the outermost side in the stacking direction of the cell stack, and an insulating layer 160 between the outermost layer and the cell stack, wherein the outermost layer includes an epoxy resin and glass particles impregnated with the epoxy resin, and the glass particles may include a boron (B) oxide, a silicon (Si) oxide, and an aluminum (Al) oxide and may not include a lithium (Li) oxide. In one example, a composition being not included in an element may mean that such a composition is not intended to be included in the element and/or is not detectable by a method/tool used to detect another composition included in the element.

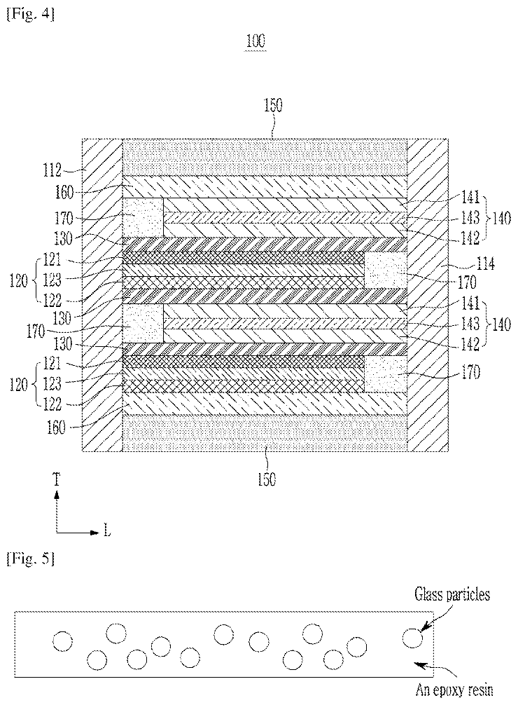

Referring to FIGS. 2 and 4, an insulating layer 160 may be disposed between the outermost layer 150 and the cell stack. When both the outermost layer 150 and the insulating layer 160 are included, insulation characteristics of the all-solid-state battery can be further enhanced.

The insulating layer 160 may include an insulating material having an ionic conductivity of less than or equal to 1.0×10⁻¹⁰ S/cm or less than or equal to 1.0×10⁻⁶ S/cm, for example, an insulating material such as the aforementioned solid electrolyte material, ceramic, or resin.

The insulating layer 160 may include a ceramic material, for example, alumina (Al₂O), bismuth trioxide (Bi₂O₃), aluminum nitride (AlN), beryllium oxide (BeO), boron nitride (BN), silicon (Si), silicon carbide (SiC), silica (SiO₂), and silicon nitride (Si₃N₄), gallium arsenide (GaAs), gallium nitride (GaN), barium titanate (BaTiO₃), zirconium dioxide (ZrO₃), a mixture thereof, an oxide and/or a nitride of these materials.

The insulating layer 160 may include an insulating resin, for example a polyolefin such as polyethylene or polypropylene and the like, a polyester such as polyethylene terephthalate (PET) and the like, polyurethane, or polyimide.

The insulating layer 160 may include an inorganic solid electrolyte including an oxide-type solid electrolyte, a sulfide-type solid electrolyte, or a combination thereof used in the solid electrolyte layer 130 described above. However, the material included in the insulating layer 160 is not limited thereto and may include various materials.

A margin layer 170 may be further disposed along edges of the positive electrode layer 120 and the negative electrode layer 140.

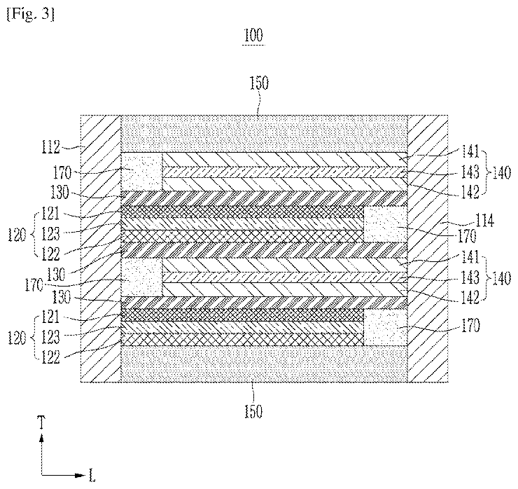

Referring to FIGS. 3 and 4, the margin layer 170 is disposed on the solid electrolyte layer 130 and is formed laterally adjacent to the edge of the positive electrode active material layers 121 and 122 or the negative electrode active material layers 141 and 142. Accordingly, the margin layer 170 may be disposed on the same layer as the positive electrode layer 120 and the negative electrode layer 140.

The margin layer 170 may include an insulating material having an ionic conductivity of less than or equal to 1.0×10⁻¹⁰ S/cm or less than or equal to 1.0×10⁻⁶ S/cm, for example, the same material as the insulating layer 160. It may include, for example, an insulating material such as the above-described solid electrolyte material, ceramic, or resin. Since this has been described above, a detailed description thereof will be omitted.

As described above, terminals of the positive current collector 123 and terminals of the negative current collector 143 are exposed on both sides of the cell stack of the all-solid-state battery 100, and external electrodes 112 and 114 may be connected to and coupled to the exposed terminals. That is, the external electrodes 112 and 114 may be configured to be connected to terminals of the positive current collector 123 to have positive properties, and connected to terminals of negative current collector 143 to have negative properties. When the terminals of the positive current collector 123 and the terminals of the negative current collector 143 are configured to face in opposite directions, the external electrodes 112 and 114 may also be disposed on both sides, respectively.

At this time, the external electrodes 112 and 114 may cover not only the cell stack but also the side of the outermost layer 150. That is, the outermost layer 150 is manufactured by being fired together by batch firing when manufacturing the cell stack, and as the external electrodes 112 and 114 are formed thereafter, the external electrodes 112 and 114 may also be disposed on the side of the outermost layer 150.

The external electrodes 112 and 114 may include a conductive metal and glass.

The conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof.

A glass component included in the external electrodes 112 and 114 may have a composition in which an oxide is mixed. The glass component may include, for example, a silicon oxide, a boron oxide, an aluminum oxide, a transition metal oxide, an alkali metal oxide, an alkaline-earth metal oxide, or a combination thereof. Herein, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba).

A method of forming the external electrodes 112 and 114 is not particularly limited. For example, the method may include dipping the cell stack in a conductive paste including a conductive metal and glass or screen-printing or gravure-printing the conductive paste on the surface of the cell stack. In addition, various methods of applying the conductive paste on the surface of the cell stack or transferring a dry film obtained by drying the conductive paste onto the cell stack may be used.

A stacked all-solid-state battery according to another embodiment includes a cell stack including a plurality of solid electrolyte layers and a plurality of positive electrode layers and negative electrode layers alternately disposed with the plurality of solid electrolyte layers interposed therebetween, an outermost layer at the outermost side in the stacking direction of the cell stack, and first and second external electrodes disposed laterally adjacent to the cell stack and the outermost layer and connected to the plurality of positive electrode layers and the plurality of negative electrode layers, respectively, wherein the outermost layer includes an epoxy resin and glass particles impregnated with the epoxy resin, and the glass particles may include a boron (B) oxide, a silicon (Si) oxide, and an aluminum (Al) oxide and may not include lithium (Li) oxide.

The stacked all-solid-state battery may further include an insulating layer between the outermost layer and the cell stack, wherein the cell stack may further include margin layers disposed laterally adjacent to edges of the positive electrode layers and the negative electrode layers.

Hereinafter, specific examples of the invention are presented. However, the examples described below are only intended to specifically illustrate or explain the invention, and the scope of the invention should not be limited thereto.

### EXAMPLES

### Example

30 wt % of glass particles (50 mol % of a boron oxide (B₂O₃), 30 mol % of a silicon oxide (SiO₂), and 20 mol % of an aluminum oxide (Al₂O₃)) are mixed with 70 wt % of a bisphenol A epoxy resin to prepare an outermost layer mixture, and the outermost layer mixture is coated on a cell stack and thermally cured at 200° C., manufacturing an all-solid-state battery cell including an outermost layer.

### Comparative Example

A comparative example is an example of not including the outermost layer unlike the example. Specifically, an insulating layer mixture including B₂O₃, SiO₂ and Bi₂O₃ is prepared and then, coated on a cell stack and thermally cured at 200° C., manufacturing an all-solid-state battery cell including an insulating layer.

### [Experimental Example] Measurement of Moisture Absorption Rate

The all-solid-state battery cells of the example and the comparative example are ion-milled or polished to prepare each portion of the outermost layer (Example) and the insulating layer (Comparative Example) into a rectangular plate piece as a sample, and each sample is exposed to 85° C. under RH 85% for 10 hours, 24 hours, and 48 hours and then, measured with respect to a weight before and after absorbing moisture, which is used to calculate a moisture absorption rate (wt %), and the results are shown in Table 1.

$$[ Moisture absorption rate ( \% ) ]$$

$$( weight of sample after moisture absorption - weight of sample before moisture absorption ) * 100 / weight of sample before moisture absorption$$

TABLE 1

| | Moisture absorption rate | | |
|---|---|---|---|
| | (wt %) (85° C./RH 85%) | | |
| | 10 hr | 24 hr | 48 hr |
| Comparative Example | 16-20 | — | — |
| Example | 0.05 | 0.08 | 0.08 |

Referring to Table 1, the example exhibits a significantly lower moisture absorption rate after 10 hours than the comparative example and thus excellent water resistance. In addition, after 24 hours and 48 hours, the moisture absorption rate of the example is maintained at 0.08% or so. While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### INDUSTRIAL APPLICABILITY

The present disclosure relates to an all-solid-state battery with improved reliability due to excellent insulation properties and moisture resistance, and can be used in various electrochemical devices and electronic devices.

### DESCRIPTION OF SYMBOLS

100: all-solid-state battery
112, 114: external electrode
120: positive electrode layer
121, 122: positive electrode active material layer
123: positive electrode current collector
130: solid electrolyte layer
140: negative electrode layer
141, 142: negative electrode active material layer
143: negative electrode current collector
150: outermost layer
160: insulating layer
170: margin layer

1. An all-solid-state battery, comprising:
a cell stack including a solid electrolyte layer, and a positive electrode layer and a negative electrode layer with the solid electrolyte layer disposed therebetween; and
an outermost layer disposed on one surface or both surfaces of the cell stack in a stacking direction of the positive electrode layer, the solid electrolyte layer, and the negative electrode layer,
wherein the outermost layer includes an epoxy resin and glass particles, and
the glass particles include a boron (B) oxide, a silicon (Si) oxide, and an aluminum (Al) oxide.

2. The all-solid-state battery of claim 1, wherein
the glass particles do not include lithium (Li) oxide.

3. The all-solid-state battery of claim 1, wherein
the glass particles further include other oxides, and the other oxides include a bismuth (Bi) oxide, a barium (Ba) oxide, a phosphorus (P) oxide, a vanadium (V) oxide, an antimony (Sb) oxide, a tin (Sn) oxide, a zinc (Zn) oxide, or a combination thereof.

4. The all-solid-state battery of claim 3, wherein
the glass particles include 20 to 80 mol % of the boron (B) oxide, 10 to 50 mol % of the silicon (Si) oxide, 5 to 25 mole of the aluminum (Al) oxide, and 0 to 20 mol % of the other oxides.

5. The all-solid-state battery of claim 1, wherein
a surface of one of the glass particles includes a silane group.

6. The all-solid-state battery of claim 1, wherein
the epoxy resin includes bisphenol A or a derivative thereof, bisphenol F or a derivative thereof, or a combination thereof.

7. The all-solid state battery of claim 1, wherein
a content of the glass particles is 20 to 50 wt % based on the total weight of the outermost layer.

8. The all-solid-state battery of claim 1, wherein
a content of the epoxy resin is 50 to 80 wt % based on the total weight of the outermost layer.

9. The all-solid-state battery of claim 1, wherein
an average thickness of the outermost layer is less than or equal to 500 μm.

10. The all-solid-state battery of claim 1, wherein
the solid electrolyte layer includes an oxide including lithium (Li), boron (B), silicon (Si), and aluminum (Al).

11. The all-solid-state battery of claim 1, wherein
the cell stack further includes a margin layer disposed laterally on edges of the positive electrode layer and the negative electrode layer.

12. An all-solid-state battery, comprising:
a cell stack including a solid electrolyte layer, and a positive electrode layer and a negative electrode layer with the solid electrolyte layer disposed therebetween;
an outermost layer disposed on one surface or both surfaces of the cell stack in a stacking direction of the positive electrode layer, the solid electrolyte layer, and the negative electrode layer; and
an insulating layer disposed between the outermost layer and the cell stack,
wherein the outermost layer includes an epoxy resin and glass particles, and
the glass particles include a boron (B) oxide, a silicon (Si) oxide, and an aluminum (Al) oxide.

13. The all-solid-state battery of claim 12, wherein
the glass particles do not include lithium (Li) oxide.

14. The all-solid-state battery of claim 12, wherein
the glass particles include other oxides and the other oxides include a bismuth (Bi) oxide, a barium (Ba) oxide, a phosphorus (P) oxide, a vanadium (V) oxide, an antimony (Sb) oxide, a tin (Sn) oxide, a zinc (Zn) oxide, or a combination thereof.

15. The all-solid-state battery of claim 14, wherein
the glass particles include 30 to 70 mol % of the boron (B) oxide, 20 to 40 mol % of the silicon (Si) oxide, 10 to 20 mol % of the aluminum (Al) oxide, and 0 to 10 mol % of the other oxides.

16. The all-solid-state battery of claim 12, wherein
the epoxy resin includes bisphenol A or a derivative thereof, bisphenol F or a derivative thereof, or a combination thereof.

17. The all-solid-state battery of claim 12, wherein
the solid electrolyte layer includes an oxide including lithium (Li), boron (B), silicon (Si), and aluminum (Al).

18. The all-solid-state battery of claim 12, wherein
a surface of one of the glass particles includes a silane group.

19. The all-solid-state battery of claim 12, wherein
the cell stack further includes a margin layer disposed laterally on edges of the positive electrode layer and the negative electrode layer.

20. A stacked all-solid-state battery, comprising:
a cell stack including:
a plurality of solid electrolyte layers, and
a plurality of positive electrode layers and negative electrode layers alternately disposed in a stacking direction with the plurality of solid electrolyte layers interposed therebetween;
an outermost layer disposed on one surface or both surfaces of the cell stack in the stacking direction; and
first and second external electrodes disposed laterally on the cell stack and the outermost layer and connected to the plurality of positive electrode layers and the plurality of negative electrode layers, respectively,
wherein the outermost layer includes an epoxy resin and glass particles, and
the glass particles include a boron (B) oxide, a silicon (Si) oxide, and an aluminum (Al) oxide.

21. The stacked all-solid-state battery of claim 20, wherein the glass particles do not include lithium (Li) oxide.

22. The stacked all-solid-state battery of claim 20, further comprising:
an insulating layer disposed between the outermost layer and the cell stack.
